(19) United States
(12) Patent Application Publication
(10) Pub. No.: US 2013/0094695 A1
(43) Pub. Date: Apr. 18, 2013

(54) METHOD AND APPARATUS FOR AUTO-DETECTING ORIENTATION OF FREE-FORM DOCUMENT USING BARCODE

(71) Applicants: Duanfeng He, South Setauket, NY (US); Adithya Krishnamurthy, Sunnyside, NY (US)

(72) Inventors: Duanfeng He, South Setauket, NY (US); Adithya Krishnamurthy, Sunnyside, NY (US)

(73) Assignee: Symbol Technologies, Inc., Holtsville, NY (US)

(21) Appl. No.: 13/272,834

(22) Filed: Oct. 13, 2011

(51) Int. Cl. G06K 9/00

(52) U.S. Cl. 382/103

(57) ABSTRACT

Method and apparatus of detecting orientation of document using a barcode decoding. The method includes (1) capturing an image of the document with an imaging arrangement having a solid-state imager; (2) determining a presence of a barcode in the captured image of the document; (3) decoding the barcode; (4) determining an up-direction of the document as a function of an orientation of the barcode in the document; and (5) setting an orientation of the document in the captured image based upon the up-direction of the document. In one implementation, the barcode is configured with orientation data indicating the up-direction of the document.

### FIELD OF THE DISCLOSURE

The present disclosure relates generally to imaging-based barcode scanners.

### BACKGROUND

Various electro-optical systems have been developed for reading optical indicia, such as barcodes. A barcode is a coded pattern of graphical indicia comprised of a series of bars and spaces of varying widths. In a barcode, the bars and spaces have differing light reflecting characteristics. Some of the barcodes have a one-dimensional structure in which bars and spaces are spaced apart in one direction to form a row of patterns. Examples of one-dimensional barcodes include Uniform Product Code (UPC), which is typically used in retail store sales. Some of the barcodes have a two-dimensional structure in which multiple rows of bar and space patterns are vertically stacked to form a single barcode. Examples of two-dimensional barcodes include Code 49 and PDF417.

Systems that use one or more solid-state imagers for reading and decoding barcodes are typically referred to as imaging-based barcode readers, imaging scanners, or imaging readers. A solid-state imager generally includes a plurality of photosensitive elements or pixels aligned in one or more arrays. Examples of solid-state imagers include charged coupled devices (CCD) or complementary metal oxide semiconductor (CMOS) imaging chips.

The imaging scanners are often used to capture images of various kinds of documents. When such a document is captured with an imaging scanner, the output image can be in any orientation. As an example, after an image of a Bank Check 300 as shown in FIG. 9A is captured with an imaging scanner, imperfections of the image of the Bank Check 300, such as skew and uneven illumination can be subject to certain corrections. The corrected image of the Bank Check 300 in FIG. 9B, however, is till upside down. For applications that rely on automatic capture and storage of such images it is an inconvenience and maybe a costly approach to use further post-processing to detect and rotate the captured images so that they are right-side up. Therefore, there is need for a method to automatically orient the output image so that it comes out the right-side up.

### SUMMARY

In one aspect, the invention is directed to a method. The method includes (1) capturing an image of the document with an imaging arrangement having a solid-state imager; (2) determining a presence of a barcode in the captured image of the document; (3) decoding the barcode; (4) determining an up-direction of the document as a function of an orientation of the barcode in the document; and (5) setting an orientation of the document in the captured image based upon the up-direction of the document. In one implementation, the barcode is configured with orientation data indicating the up-direction of the document.

Implementations of the invention can include one or more of the following advantages. When a document is captured with an imaging scanner, the output image can be automatically oriented so that it comes out the right-side up. These and other advantages of the present invention will become apparent to those skilled in the art upon a reading of the following specification of the invention and a study of the several figures of the drawings.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows an imaging scanner in accordance with some embodiments.

FIG. 2 is a schematic of an imaging scanner in accordance with some embodiments.

FIG. 3 shows three kinds of exemplary forms that can be captured by the imaging scanners.

FIG. 4A shows a captured digital image of the form 2 in FIG. 3 in accordance with some embodiments.

FIG. 4B shows an improved image of the form in FIG. 4A after a reference box bounding the barcode is transformed into a rectangle in accordance with some embodiments.

FIG. 5 is a flowchart of a method for decoding the barcode in a form captured by an imaging scanner in accordance with some embodiments.

FIG. 6 is a flowchart that shows the process of block 220 in FIG. 5 with more details in accordance with some embodiments.

FIG. 7 depicts some exemplary “parallel” lines used in an algorithm for finding the reference box for correcting imaging distortions.

FIG. 8 depicts some exemplary connected-components used in an algorithm for finding the reference box for correcting imaging distortions.

FIG. 9A shows that an image of a Bank Check is captured with an imaging scanner in accordance with some embodiments.

FIG. 9B shows an image of the Bank Check after some imperfections of the image of the Bank Check in FIG. 9A, such as skew, is corrected in accordance with some embodiments.

FIG. 10 shows that the image of the Bank Check is set to the correct orientation in accordance with some embodiments.

FIG. 11 shows a method to put the image of the Bank Check in the correct orientation in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

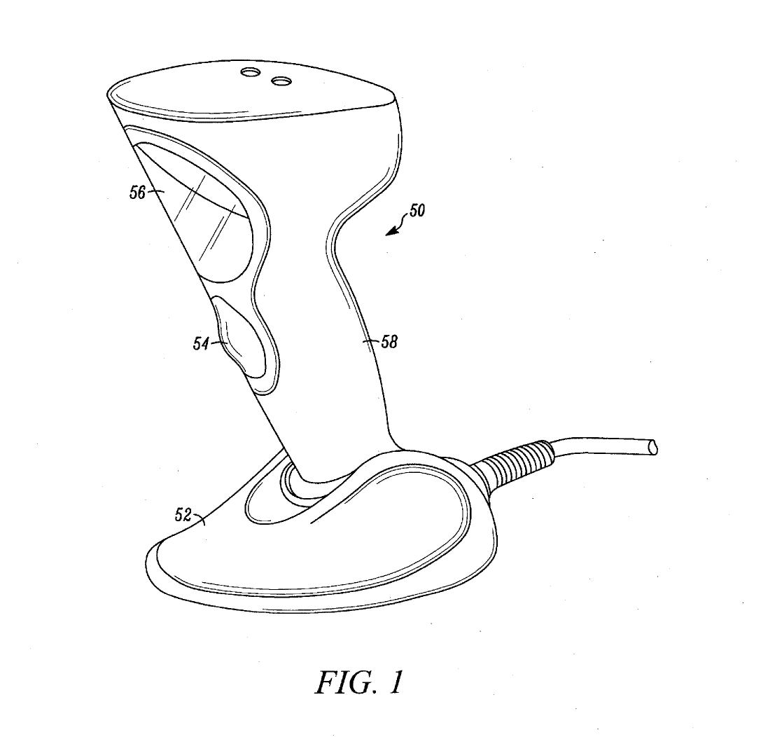

FIG. 1 shows an imaging scanner 50 in accordance with some embodiments. The imaging scanner 50 has a window 56 and a housing 58 with a handle. The imaging scanner 50 also has a base 52 for supporting itself on a countertop. The imaging scanner 50 can be used in a hands-free mode as a stationary workstation when it is placed on the countertop. The imaging scanner 50 can also be used in a handheld mode when it is picked up off the countertop and held in an operator's hand. In the hands-free mode, products can be slid, swiped past, or presented to the window 56. In the handheld mode, the imaging scanner 50 can be moved towards a barcode on a product, and a trigger 54 can be manually depressed to initiate imaging of the barcode. In some implementations, the base 52 can be omitted, and the housing 58 can also be in other shapes. In FIG. 1, a cable is also connected to the base 52. In other implementations, when the cable connected to the base 52 is omitted, the imaging scanner 50 can be powered by an on-board battery and it can communicate with a remote host by a wireless link.

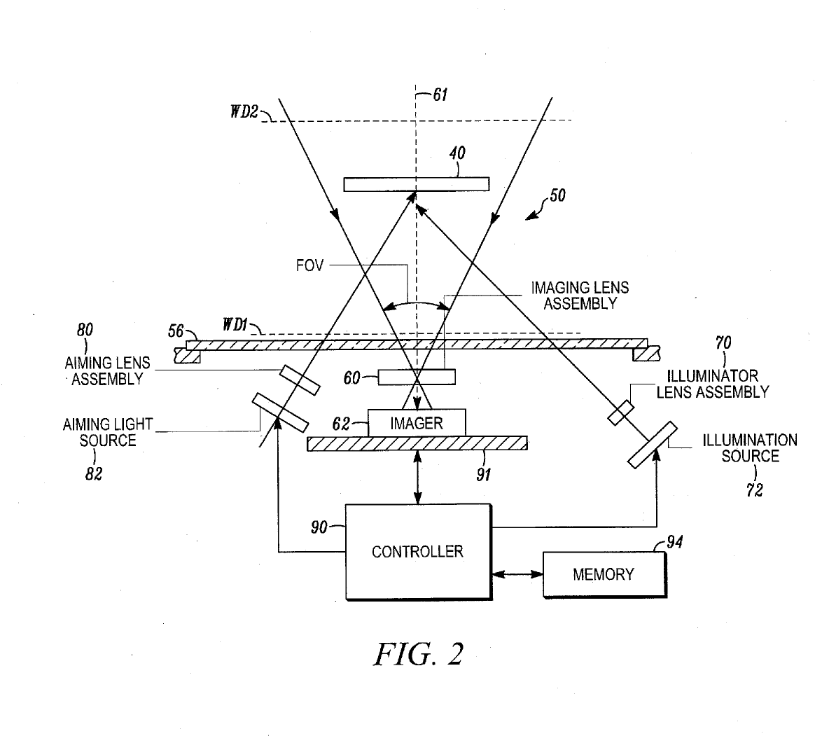

FIG. 2 is a schematic of an imaging scanner 50 in accordance with some embodiments. The imaging scanner 50 in FIG. 2 includes the following components: (1) a solid-state imager 62 positioned behind an imaging lens assembly 60; (2) an illuminating lens assembly 70 positioned in front of an illumination source 72; (3) an aiming lens assembly 80 positioned in front of an aiming light source 82; and (4) a controller 90. In FIG. 2, the imaging lens assembly 60, the illuminating lens assembly 70, and the aiming lens assembly 80 are positioned behind the window 56. The solid-state imager 62 is mounted on a printed circuit board 91 in the imaging scanner.

The solid-state imager 62 can be a CCD or a CMOS imaging device. The solid-state imager 62 generally includes multiple pixel elements. These multiple pixel elements can be formed by a one-dimensional array of photosensitive elements arranged linearly in a single row. These multiple pixel elements can also be formed by a two-dimensional array of photosensitive elements arranged in mutually orthogonal rows and columns. The solid-state imager 62 is operative to detect light captured by an imaging lens assembly 60 along an optical axis 61 through the window 56. Generally, the solid-state imager 62 and the imaging lens assembly 60 are designed to operate together for capturing light scattered or reflected from a barcode 40 as pixel data over a two-dimensional field of view (FOV).

The barcode 40 generally can be located anywhere in a working range of distances between a close-in working distance (WD1) and a far-out working distance (WD2). In one specific implementation, WD1 is about a few inches from the window 56, and WD2 is about a few feet from the window 56. Some of the imaging scanners can include a range finding system for measuring the distance between the barcode 40 and the imaging lens assembly 60. Some of the imaging scanners can include an auto-focus system to enable a barcode be more clearly imaged with the solid-state imager 62 based on the measured distance of this barcode. In some implementations of the auto-focus system, the focus length of the imaging lens assembly 60 is adjusted based on the measured distance of the barcode. In some other implementations of the auto-focus system, the distance between the imaging lens assembly 60 and the solid-state imager 62 is adjusted based on the measured distance of the barcode. As will be discussed in further detail below, the solid state imager 62 may be configured to also locate the barcode 40 within a document when a location thereof is unknown.

In FIG. 2, the illuminating lens assembly 70 and the illumination source 72 are designed to operate together for generating an illuminating light towards the barcode 40 during an illumination time period. The illumination source 72 can include one or more light emitting diodes (LED). The illumination source 72 can also include a laser or other kind of light sources. The aiming lens assembly 80 and the aiming light source 82 are designed to operate together for generating a visible aiming light pattern towards the barcode 40. Such aiming pattern can be used by the operator to accurately aim the imaging scanner at the barcode. The aiming light source 82 can include one or more light emitting diodes (LED). The aiming light source 82 can also include a laser or other kind of light sources.

In FIG. 2, the controller 90, such as a microprocessor, is operatively connected to the solid-state imager 62, the illumination source 72, and the aiming light source 82 for controlling the operation of these components. The controller 90 can also be used to control other devices in the imaging scanner. The imaging scanner 50 includes a memory 94 that can be accessible by the controller 90 for storing and retrieving data. In many embodiments, the controller 90 also includes a decoder for decoding one or more barcodes that are within the field of view (FOV) of the imaging scanner 50. In some implementations, the barcode 40 can be decoded from an original document through processing the barcode with a microprocessor once the location of the barcode is ascertained. For example, the location of the barcode may already be known or determined

In operation, in accordance with some embodiments, the controller 90 sends a command signal to energize the illumination source 72 for a predetermined illumination time period. The controller 90 then exposes the solid-state imager 62 to capture an image of the barcode 40. The captured image of the barcode 40 is transferred to the controller 90 as pixel data. Such pixel data is digitally processed by the decoder in the controller 90 to decode the barcode. The information obtained from decoding the barcode 40 is then stored in the memory 94 or sent to other devices for further processing.

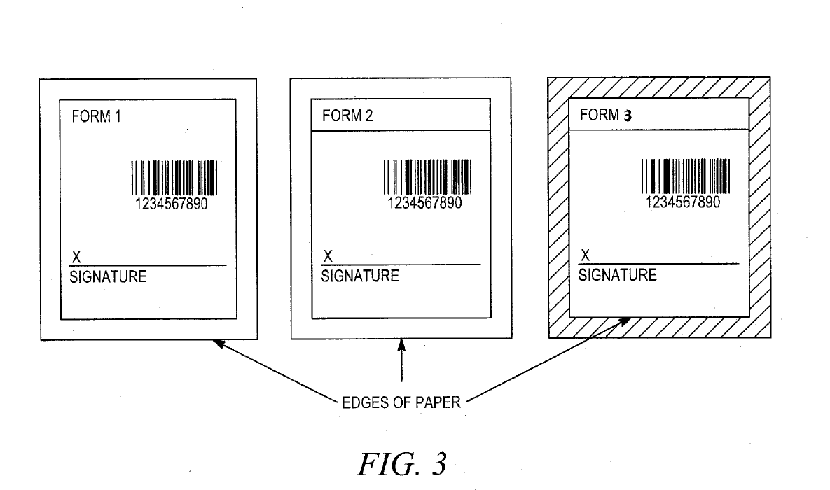

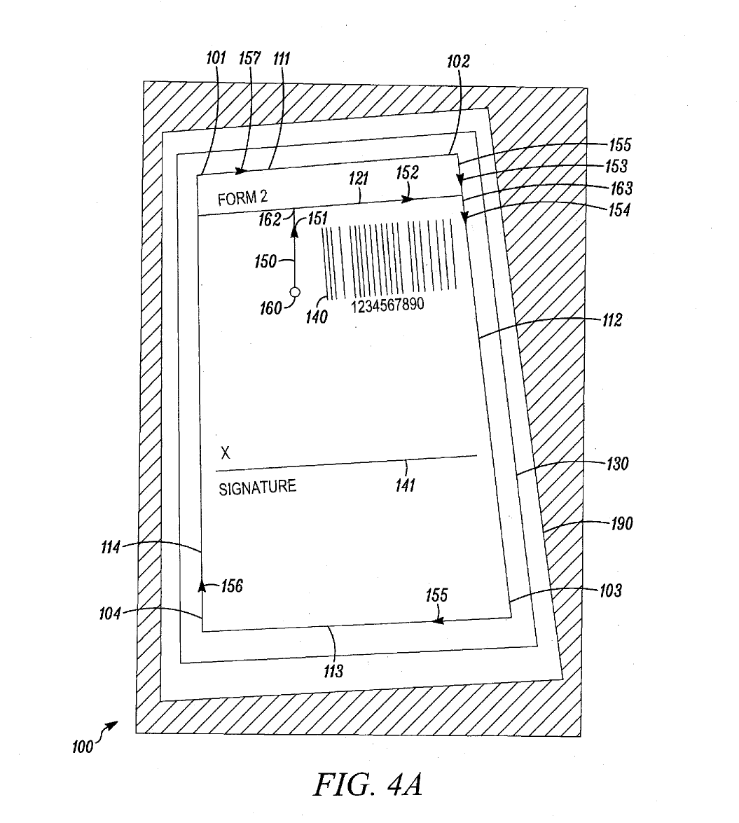

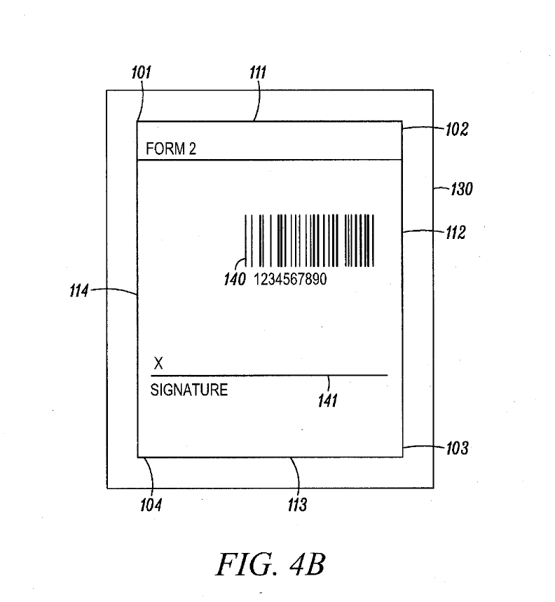

When a form document is captured by an imaging scanner 50, the form as it appears in the captured digital image sometimes can be tilted, skewed, and distorted. As an example, FIG. 4A shows a captured digital image 100 of the form 2 in FIG. 3. Apparently, the form image in the captured digital image 100 is no longer rectangular in shape. Thus, according to the exemplary embodiments, the captured digital image 100 is processed so that an orientation is determined (e.g., an up-direction), thereby the captured digital image 100 is represented with a proper view. FIG. 3 further shows a captured digital image of a form 1 in which a line 121 present in form 2 but absent in form 1 as well as a captured digital image of a form 3 in which the edges of the document are within the area of the captured image.

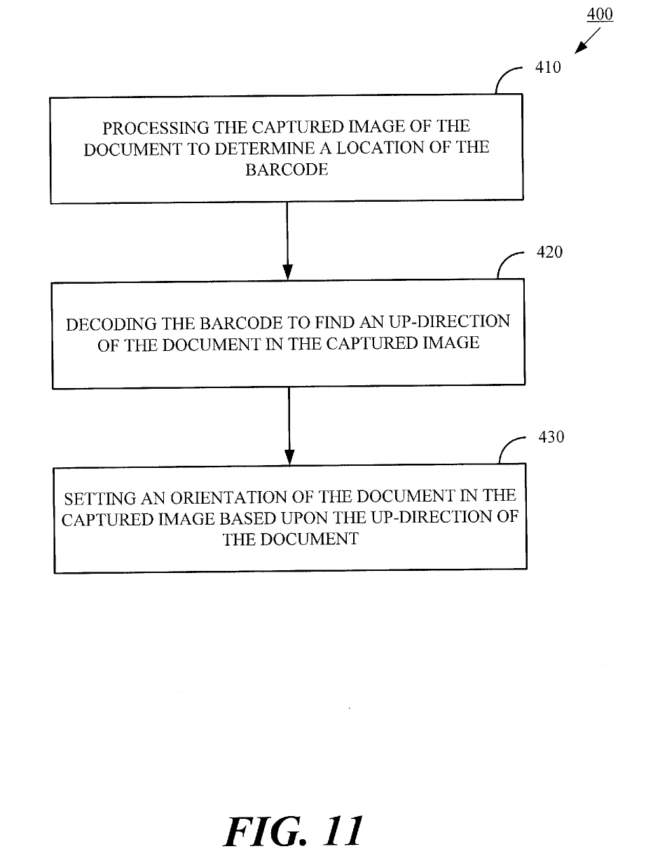

According to the exemplary embodiments, the captured digital image 100 may be captured by the imaging scanner 50. However, as will be explained in further detail below, prior to capturing and processing the captured digital image 100, a barcode may be decoded to determine an orientation of the captured digital image 100 so that when processed, the proper viewing orientation may be determined Through an initial determination of the orientation of the document, the necessary processing of the captured digital image 100 may be minimized For example, if the document does not include a barcode, the document may only be captured without requiring the subsequent processing that would otherwise be performed. In another example, if the document includes a barcode, by determining the presence and/or location of the barcode prior to processing the captured digital image 100, processing may be minimized compared to a method that assumes a barcode is present and performs further steps that would otherwise be unnecessary. In addition, those skilled in the art will understand that decoding a barcode in an original document compared to an image of a document is more reliable and that the prior decoding of the barcode requires less time than performing numerous steps prior to the decoding. Therefore, according to the exemplary embodiments, when the location of the barcode is known, the barcode may first be scanned on the original document and decoded to extrapolate the data encoded therein which may include orientation data of the document such as an up-direction. As will be described in further detail below, in particular with FIG. 11, the captured digital image 100 may be stored and/or viewed with a correct orientation.

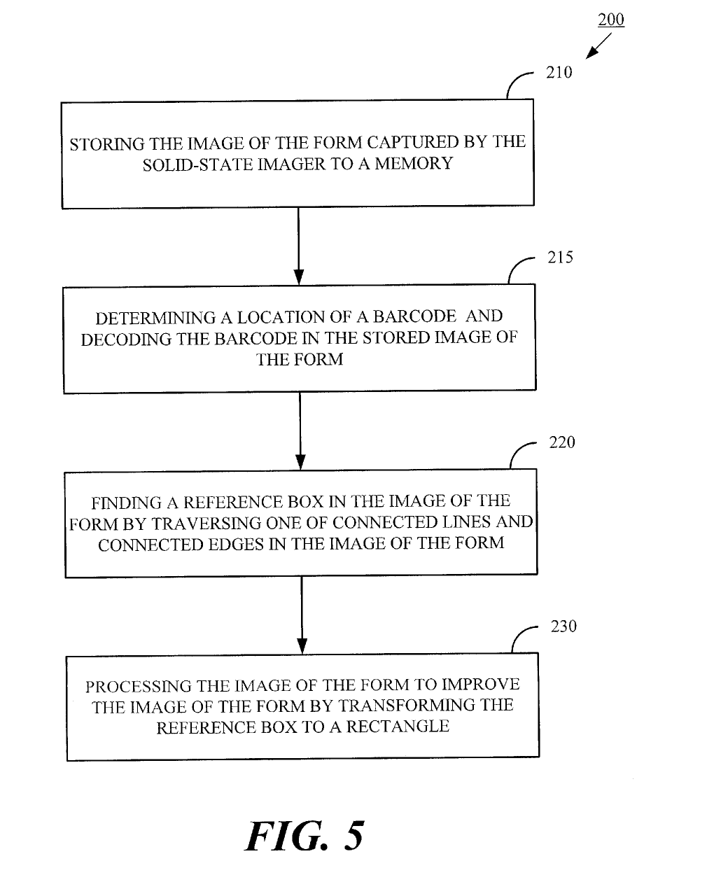

FIG. 5 is a flowchart of a method 200 for decoding a barcode in a form captured by an imaging scanner in accordance with some embodiments. The method 200 includes blocks 210, 220, 230, and 240. At block 210, the image of the form captured by the solid-state imager is stored to a memory. At block 215, a location of the barcode in the stored image is determined and subsequently decoded. The location and decoding may be performed regardless of the orientation in which the form is captured in the image. At block 220, one of connected lines and connected edges in the image of the form are traversed to find a reference box in the image of the form. At block 230, with a process in which the reference box is transformed into a rectangle, the image of the form is improved. In one example, in the captured digital image 100 of FIG. 4A, a reference box bounded by lines 111, 112, 113, and 114 (with corner points 101, 102, 103, and 104) is transformed into a rectangle in FIG. 4B, which is also bounded by lines 111, 112, 113, and 114 (with corner points 101, 102, 103, and 104). In one example, after the reference box in FIG. 4A bounded by lines 111, 112, 113, and 114 is transformed into a rectangle in FIG. 4B, the image of the document may be improved.

FIG. 4A also depicts an exemplary process of block 220, in which one of connected lines and connected edges in the image of the form 100 are traversed to find a reference box in the image of the form. As shown in FIG. 4A, after a barcode candidate 140 in the image of the form 100 is identified, a position in the neighborhood of the barcode candidate is selected as a start position 160 for a tracer. As discussed above, according to an exemplary embodiment, an attempt may be made or initially be made to decode the barcode candidate 140, in step 215, prior to performing the subsequent steps. Beginning from the start position 160, the tracer 151 moves along a line 150 until it encounters line 121. Based on a direction-scan algorithm, the tracer will make a right turn and continue to move along line 121 as tracer 152. When tracer 152 moves to line 112 that encounters line 121, based on the direction-scan algorithm, the tracer again will make a right turn at a position 163 and continue to move along line 112 as tracer 154. Similarly, based on the direction-scan algorithm, the tracer continues to traverse line 113 as tracer 155, traverse line 114 as tracer 156, traverse line 111 as tracer 157, and traverse line 112 as tracer 153, until the tracer return to the position 163 that has been previously traced by the tracer.

In FIG. 4A, the direction-scan algorithm determines the direction of travel whenever the tracer moves to a position where it encounters a new line. With the direction-scan algorithm, it first determines whether the position where it encounters the new line is the most “upper right” point since the beginning of the traverse by the tracer. If such position is the most “upper right” point, the algorithm start to search the new direction for travel by scanning a direction clock-wise beginning from the up direction of the image and ending the search when the new direction for travel is found. If such position is not the most “upper right” point, the algorithm start to search the new direction for travel by scanning a direction clock-wise beginning from the 9 o'clock direction relative to the tracer's current direction of travel. In the example as shown in FIG. 4A, at the point 163 where line 121 meets line 112, the search starts from the “up” direction, because the last point was the most “upper right” point to this moment. The algorithm starts from this direction, scans around to the right, and finds the first “border” point on the lower part of the line 112. It can be easily verified that the same algorithm will trance a straight line, and will turn right when the border line turns right. But when line 114 meets 121, the tracer did not happen to start from a new “upper right” point. Consequently it scans from the 9 o'clock direction in relationship to its current movement, and finds the next point to travel in the upper part of line 114, instead of the line 121.

FIG. 4A, once the closed area bounded by the straight lines 111, 112, 113, and 114 is found, it is evaluated to determine whether this closed area represents a rectangle (optionally with perspective distortion), and whether the rectangle is sufficiently large. A contour could be a random shape instead of a rectangle, if it is the outline of a block of the barcode, for example. A contour could be a very small rectangle if it is the outline of a single bar of a barcode, or the check-box of an item on the form, for example. If the area enclosed by the contour is in the form of a rectangle with perspective distortion and is sufficiently large, then, it is selected as a reference box. After this reference box bounded by lines 111, 112, 113, and 114 is transformed into a rectangle in FIG. 4B, the location of the barcode 140 from the image in FIG. 4B can be used to determine the location of the barcode in the original image so that the barcode can be decoded from the original image.

In the implementation as illustrated in FIG. 4B, the tracer has been consistently making a right turn whenever the tracer moves to a position where the line on which it moves along encounters a new line, because the direction-scan algorithm searches the new direction for travel by scanning a direction clock-wise. In an alternative implementation, the direction-scan algorithm can also search the new direction for travel by scanning a direction counter-clock-wise, and people skilled in the art can easily make the necessary modifications of the clock-wise search algorithm to come up with the new counter-clock-wise search algorithm.

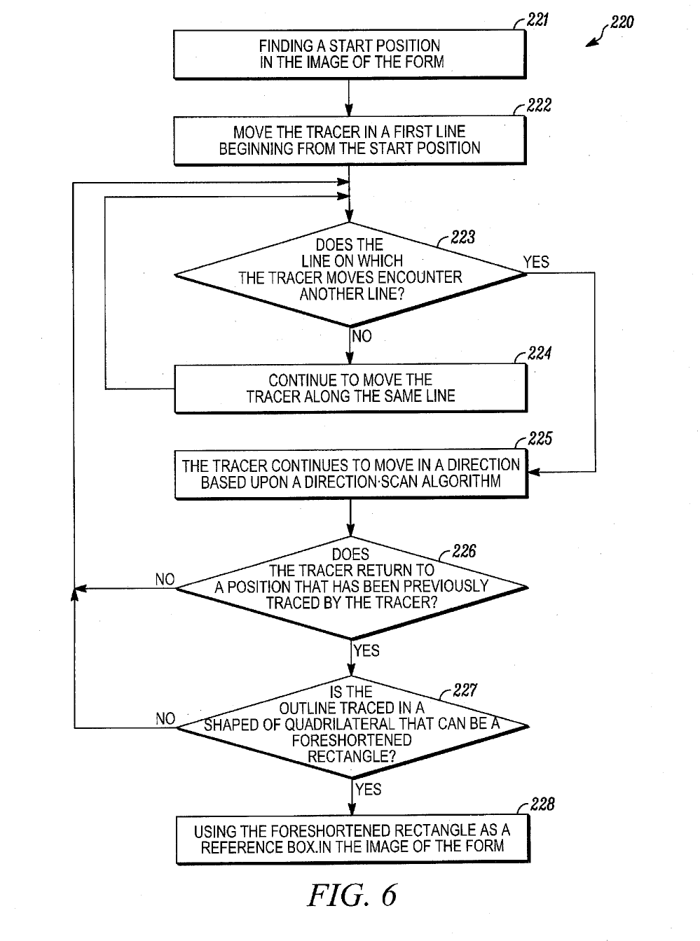

FIG. 6 is a flowchart that shows the process of block 220 in more details. The process of block 220 includes blocks 221, 222, 223, 224, 225, 226, 227, and 228. At block 221, a start position in the image of the form is found. At block 222, the tracer moves in a first line beginning from the start position. At block 223, it is determined whether the line on which the tracer moves encounters another line. If it does not encounter another line, at block 224, the tracer continues to move along the same line; but if it encounters another line, at block 225, the tracer continues to move in a direction based upon a direction-scan algorithm. At block 226, it is determined whether the tracer returns to a position that has been previously traced by the tracer. If the tracer returns to a previous position, at block 227, it is determined whether the outline traced is in a shape of quadrilateral that can be a foreshortened rectangle. If the answer to the question at block 227 is affirmative, at block 228, the outline traced will be used as a reference box in further signal processing; otherwise, the tracer continues to traverse the lines in the form. In some implementations, the questions at block 227 also include (a) “Is the rectangle large enough?” and/or (b) “Does the quadrilateral enclose the starting point?” In such implementation, the outline traced will be used as a reference box in further signal processing, only if the answers to the questions at block 227 are all affirmative.

The process of block 220 allows the imaging scanner to determine the type of the forms. For example, the process of block 220 may start from the neighborhood of the barcode, and gets an outside contour of the background area. From the contour, analysis is done to determine if there is a border line around it—if there is not, the contour itself represents the edge of the form (Form 3 shown in FIG. 3). If there is a border line, a contour trace of the outside border of the line is performed. The outer contour thus generated is taken as the boundary of the form (Form 1 or 2 shown in FIG. 3).

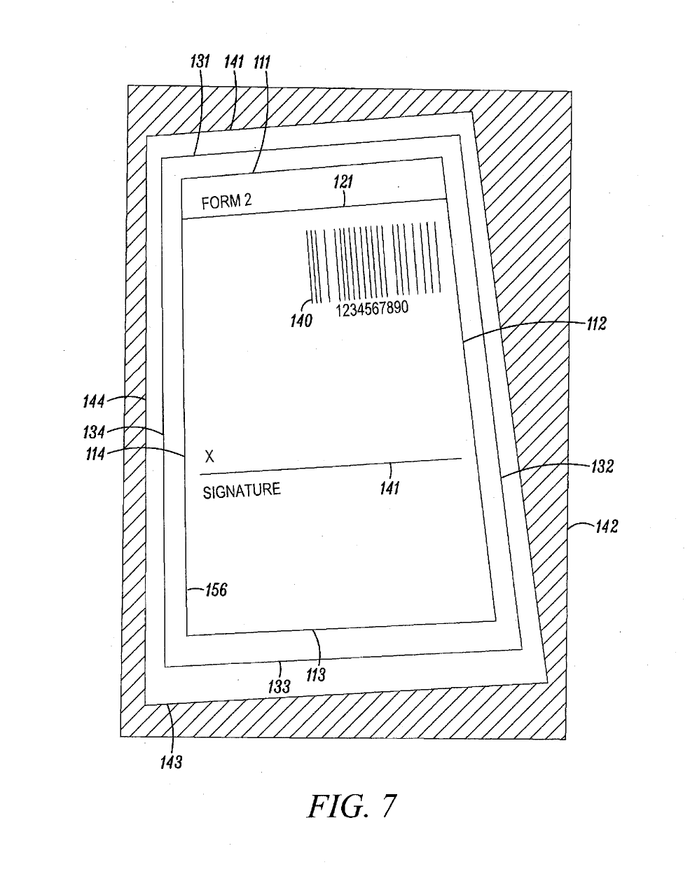

In addition to the flowchart as shown in FIG. 6, there are also other algorithms for finding the reference box of the barcode and may also be used for correcting imaging distortions. With one such algorithm, all lines which are “parallel” to the barcode bounding box can be first searched with a microprocessor, where the word “parallel” is understood to take into account of the foreshortening as predicted by the barcode bounding box. Once we have this set of lines, or a subset of it, we can use line- or contour-tracing algorithms to find the reference box. In one example, as shown in FIG. 7, the first set of “parallel” lines can include line 131, line 111, line 121, line 141, line 113, line 133, and line 143, while the second set of “parallel” lines can include line 142, line 132, line 112, line 114, line 134, and line 144.

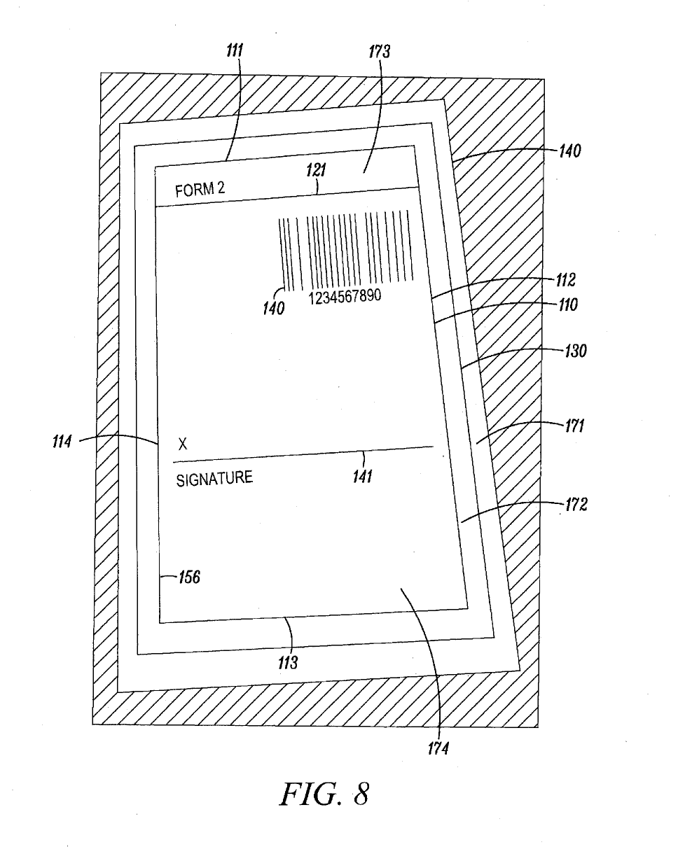

One of the other algorithms for finding the reference box involves connected-component analysis. With this algorithm, the background (white part) in the form is first found by a microprocessor. Note that the background around the barcode may not be connected with the complete background area, due to possible segmentation of the background by some lines in the form design (e.g. Form 2 shown in FIG. 3). However, if we then follow the lines surrounding this background area to find an outside contour, we should be able to arrive at the border. If we find that, at least on one side, there is no line separating this background from the rest of the image, we can conclude that the form is the type like Form 3, bounded by the edge of a piece of paper. As shown in FIG. 8, examples of the connected-components include the white area 171 between box 140 and box 130, the white area 172 between box 130 and box 110, and the white area 173 within box 110 but bounded by lines 111 and 121. Another example of the connected-components is the white area 174 within box 110, bounded by lines 121 and 113 and excluding those dark areas within box 110 (e.g., signature line 141, the barcode image 140, and other dark areas).

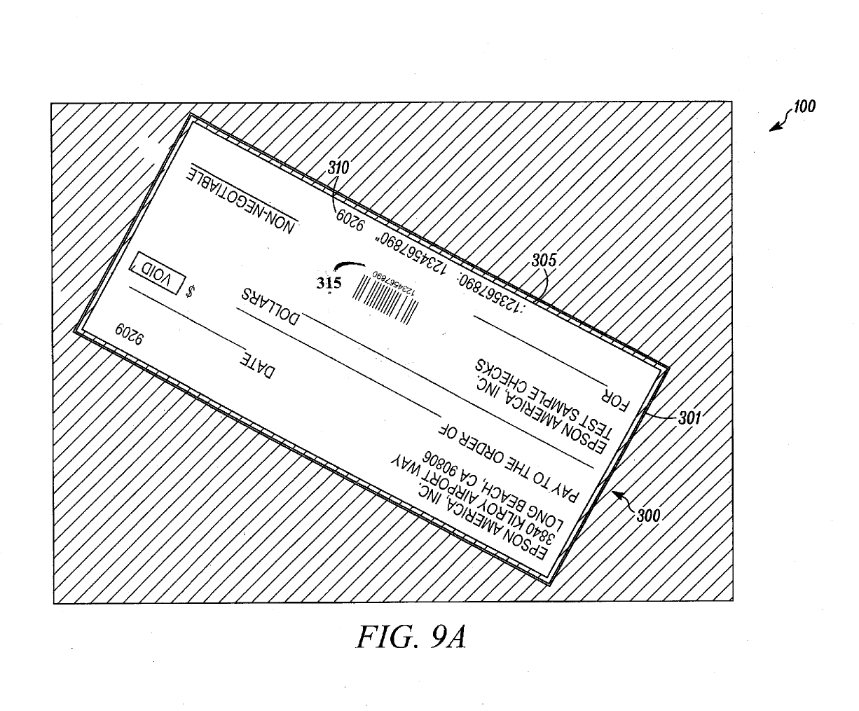

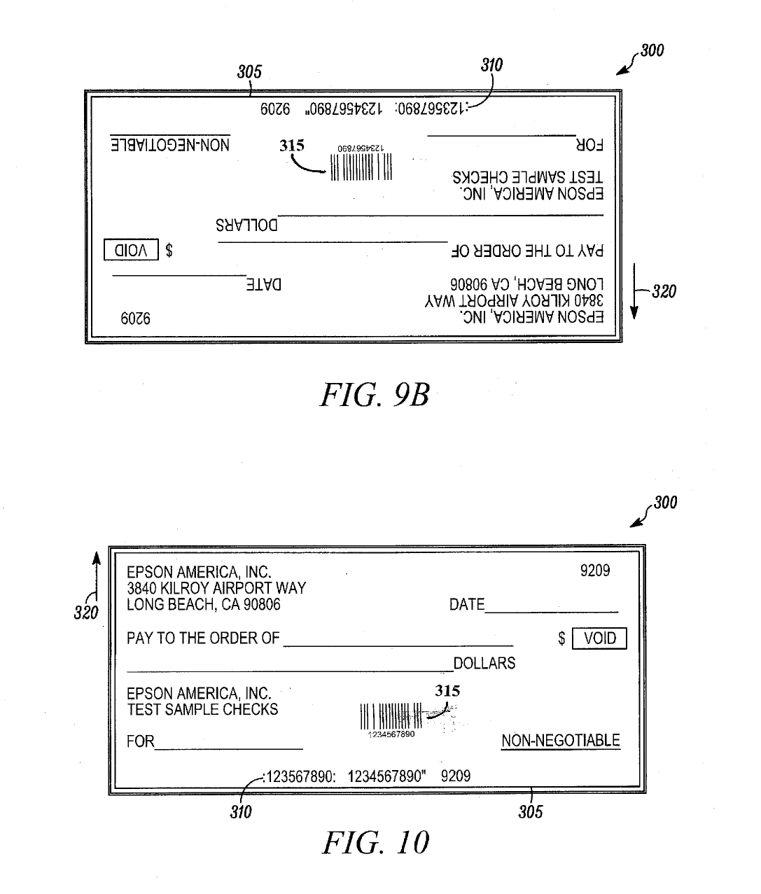

The method described previously can also be used to correct imperfections in the images of other kinds of documents. For example, after an image of a Bank Check 300 as shown in FIG. 9A is captured with an imaging scanner, imperfections of the image of the Bank Check 300, such as skew and uneven illumination can be subject to certain corrections. The corrected image of the Bank Check 300 is shown in FIG. 9B. In fact, other than the methods disclosed in this disclosure, imperfections in the image of a document, such as skew, can also be corrected with other methods known to the people skilled in the art.

In FIG. 9B, while the image of the Bank Check 300 is in the form of a rectangular after the correction, the corrected image of the Bank Check 300 in FIG. 9B is still upside down. FIG. 11 shows a method 400 to put the image of the Bank Check 300 in the correct orientation in accordance with some embodiments of the invention. The method 400 includes blocks 410, 420, and 430. It should again be noted that the method being performed to generate the corrected image illustrated in FIG. 9B is only exemplary. As discussed above, the barcode 315 in FIG. 9A may be decoded first upon locating the barcode 315 and the orientation of the document may be determined.

At block 410, the captured image of the document is processed to determine a location of the barcode. As described above, the exemplary embodiments may utilize an algorithm to determine a location of the barcode such as the a tracing algorithm described with reference to FIG. 5 which may be used to determine a rectangle that includes the barcode to be decoded. In some embodiments, the reference box is defined by edges of the document. In other embodiments, the reference box can be defined by other features, such as, a box in a form, or parallel lines in a table. In the example as shown in FIG. 9A, the reference box can be provided by the edges 301 of the Bank Check 300 in the image. In FIG. 9A, the reference box can be provided by the decoration lines 305 near the edges of the Bank Check 300 of the Bank Check 300 in the image. After the captured image of the document is processed at block 410, the location of the barcode can be used to find a location of the barcode in the original document. FIG. 9B shows an improved image of the Bank Check 300, after certain imperfections are corrected. In some embodiments of block 410, imperfections due to non-uniformity of the illuminations can also be corrected.

At block 420, the barcode is decoded. It should be noted that the barcode may be decoded from an image or from an original source. In some embodiments, the barcode can include a plurality of lines and spaces in a predetermined orientation such as in a one-dimensional barcode. An image of a one-dimensional barcode may include imperfections that may alter a width of at least one of the lines or spaces in the one-dimensional barcode. In further embodiments, the barcode can include a plurality of blocks and spaces in a predetermined orientation such as in a two-dimensional barcode. A substantially similar imperfection may exist in an image in which a block may be disposed when a space should be, and vice versa. Thus, from determining the location of the barcode in the previous step, a corresponding location in the original document may be determined that would include the barcode. In the example as shown in FIG. 9B, the barcode 315 on the Bank Check 300 can be searched with certain imaging processing processes.

Furthermore, at block 420, after the location of the barcode is determined, such barcode can be decoded to find an up-direction of the document in the captured image. In the example as shown in FIG. 9B, the barcode 315 can be decoded to find an up-direction 320 of the Bank Check 300. In FIG. 9B, the up-direction 320 of the Bank Check 300 is pointed downward, indicating that the image of the Bank Check 300 in FIG. 9B needs to be rotated, flipped, or otherwise reoriented. The barcode 315 can include additional data encoded therein to indicate its orientation with regard to the document on which it is disposed. For example, when the barcode 315 has an orientation that is aligned with the document, the barcode 315 may indicate, upon decoding, that the barcode 315 is aligned therewith. In another example, when the barcode 315 has an orientation that is perpendicular with the document, the barcode 315 may indicate, upon decoding, that the barcode 315 is oriented one of clockwise or counter-clockwise 90° with regard to the up-direction 320. In yet another exemplary embodiment, an alignment of the barcode 315 can be determined Specifically, an up-direction of the barcode 315 can be determined When the barcode 315 is oriented with an internal up-direction aligned with the document, the up-direction 320 can also be determined in this manner.

At block 430, the correct orientation of the document in the captured image can be set based upon the up-direction 320 of the document that was found by the process at block 420. If the up-direction 320 of the document is pointed upward and in good alignment with the pixels in the image containing the document, the orientation of the document may not need to be changed. If the up-direction 320 of the document is not pointed upward, the image of the document needs to be reoriented. In FIG. 9B, the up-direction 320 of the Bank Check 300 is pointed downward. The image of the Bank Check 300 in FIG. 9B can be rotated 180 degrees to set the image of the Bank Check 300 at the correct orientation as shown in FIG. 10.

According to still other exemplary embodiments, the method 400 can assume that the barcode is present within the document in which an image is to be captured. For example, the location of the barcode may be predetermined and the location may thus be known. Therefore, upon decoding the barcode at the known location, an orientation may initially be determined Subsequently, an image can be captured for the document with the further advantage of the captured image already being in the proper orientation based upon the up-direction of the document.

According to further exemplary embodiments, the method 400 can proceed with the assumption that the barcode is not present. However, the method 400 still enables the image capture functionality from being performed. To address this scenario, a challenge may be presented to the image capture component. Through user-definable parameters, the challenge can instruct the scanner to wait a predetermined amount of time, a number of image frames, etc. prior to assuming the document does not contain a barcode. If a barcode is decoded within the allotted time, the method 400 can proceed as described above. If the presence of the barcode is not determined or the barcode is not decoded, the method 400 can still perform block 410 in which an image is to be captured.

It should be noted that the method 400 is only exemplary. Specifically, the use of only the barcode 315 to determine the up-direction is an exemplary embodiment for a method to properly orient the captured image of the document. Further exemplary embodiments can incorporate further criteria to determine and/or verify the up-direction of the document. For example, an analysis of the OCR string 310 may also be used to verify the up-direction 320 of the document.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
capturing an image of a document with an imaging arrangement, wherein the imaging arrangement comprises a solid-state imager having an array of photosensitive elements, a lens system operative to focus light reflected from the document onto the array of photosensitive elements in the solid-state imager;
determining a presence of a barcode in the captured image of the document;
decoding the barcode;
determining an up-direction of the document as a function of an orientation of the barcode in the document; and
setting an orientation of the document in the captured image based upon the up-direction of the document.

2. The method of claim 1, further comprising:
processing the captured image of the document to improve the captured image of the document by transforming a reference box to a rectangle.

3. The method of claim 2, wherein the reference box is defined by one of edges of the document and edges of the barcode.

4. The method of claim 1, wherein the imaging arrangement is a barcode reading arrangement.

5. The method of claim 1, wherein the document includes one of a Bank Check, a Utility Bill, and a Postal Application.

6. The method of claim 1, wherein the barcode is one of a one-dimensional barcode and a two-dimensional barcode.

7. An apparatus comprising:
a solid-state imager having an array of photosensitive elements for capturing an image of a document;
a lens system operative to focus light reflected from the document onto the array of photosensitive elements in the solid-state imager; and
a processor configured for
determining a presence of a barcode in the captured image of the document,
decoding the barcode,
determining an up-direction of the document as a function of an orientation of the barcode in the document, and
setting an orientation of the document in the captured image based upon the up-direction of the document.

8. The apparatus of claim 7, wherein the processor is further configured for processing the captured image of the document to improve the captured image of the document by transforming a reference box to a rectangle.

9. The apparatus of claim 8, wherein the reference box is defined by one of edges of the document and edges of the barcode.

10. The apparatus of claim 7, wherein the document includes one of a Bank Check, a Utility Bill, and a Postal Application.

11. The apparatus of claim 7, wherein the barcode is one of a one-dimensional barcode and a two-dimensional barcode.

12. A method comprising:
capturing an image of a document having a barcode with an imaging arrangement, wherein the imaging arrangement comprises a solid-state imager having an array of photosensitive elements, a lens system operative to focus light reflected from the document onto the array of photosensitive elements in the solid-state imager;
storing into a memory a captured image of the document obtained by the solid-state imager;
performing barcode decoding on the barcode in the captured image of the document to find an up-direction of the document in the captured image as a function of an orientation of the barcode in the document; and
setting an orientation of the document in the captured image based upon the up-direction of the document.

13. The method of claim 12, wherein barcode is one of a one-dimensional barcode and a two-dimensional barcode.

14. The method of claim 12, wherein the barcode includes orientation data related to the up-direction of the document.

15. The method of claim 12, further comprising:
processing the captured image of the document to improve the captured image of the document by transforming a reference box to a rectangle.

16. The method of claim 15, wherein the reference box is defined by one of edges of the document and edges of the barcode.

17. The method of claim 12, wherein the imaging arrangement is a barcode reading arrangement.

18. An apparatus comprising:
a solid-state imager having an array of photosensitive elements for capturing an image of a document;
a lens system operative to focus light reflected from the document onto the array of photosensitive elements in the solid-state imager;
a memory operative to store a captured image of the document obtained by the solid-state imager; and
a processor configured for
performing barcode decoding on a barcode in the captured image of the document to find an up-direction of the document in the captured image as a function of an orientation of the barcode in the document; and
setting an orientation of the document in the captured image based upon the up-direction of the document.

19. The apparatus of claim 18, wherein the barcode is one of a one-dimensional barcode and a two-dimensional barcode.

20. The apparatus of claim 18, wherein the barcode includes orientation data related to the up-direction of the document.

21. The apparatus of claim 18, wherein the processor is further configured for processing the captured image of the document to improve the captured image of the document by transforming a reference box to a rectangle.

22. The apparatus of claim 21, wherein the reference box is defined by one of edges of the document and edges of the barcode.
